(19) United States
(12) Patent Application Publication
(10) Pub. No.: US 2009/0096139 A1
(43) Pub. Date: Apr. 16, 2009

(54) Surface Treatment Process for Ceramic Mechanical Seal Rings of Pumps and Ring Obtained With Said Process

(76) Inventors: Italo Zambotto, Terni (IT); Francesco Valentini, Spoleto (IT)

Correspondence Address: Robert M. Gamson;Hodes, Pessin & Katz, 901 Dulaney Valley Road, Suite 400, Towson, MD, 21204, US

(21) Appl. No.: 12/084,876

(22) PCT Filed: Oct. 12, 2006
(86) PCT No.: PCT/IT2006/000731

§ 371 Date: May 9, 2008

(30) Foreign Application Priority Data
Nov. 15, 2005 (IT) MC2005A000120

(51) Int. Cl. B28B 3/02; F16J 15/00

(52) U.S. Cl. 264/678; 277/358

(57) ABSTRACT

The present invention relates to a surface treatment process for ceramic mechanical seal rings of pumps, of the type comprising a first cold-moulding process of the ceramic powders in a suitable die and a second sintering process of the ring, characterised in that the moulding process is performed with a punch with head provided with a plurality of punctiform micro-projections; another object of the present invention is the seal ring obtained with the said process.

The present patent application for industrial invention relates to a surface treatment process of seal rings for pumps used in the automotive, industrial and household appliance sectors, together with the ring obtained with said process.

The advantages of the said process will become evident following to a brief description of the prior technique with relevant drawbacks.

As it is known, in the aforementioned types of pumps leakage must be avoided in the area between the revolving shaft and the corresponding fixed housing.

Front seals consisting of two cooperating rings (of which at least one ring is made of ceramic material, normally silicon carbide) are provided to that end, one ring being fitted to the revolving shaft and the other ring being fixed on the pump-assembly.

In particular, the rings are maintained in contact through the action of suitable means, rubbing themselves during the operation of the pump and thus avoiding undesired leakage.

However, the sealing action of the rings is improved if the front surface of the rings is characterised by microporosity, in addition to perfect planarity.

Because of microporosity, a very thin film of intermediate liquid is formed continuously between the rubbing surfaces of the two rings, being a very important factor for the good seal of the device.

The rings used in this type of seals are mostly obtained from ceramic powders, mostly silicone carbide, which are first moulded (or “cold-moulded”) by means of a punch that moulds and compacts the powders contained in a suitable die and then subjected to high-temperature sintering process in order to “bind” and irreversibly harden the powders.

So far, the processes used to favour the creation of micro-porosity on the surface of the said rings are performed after the cold-moulding process of powders, according to two main alternative technologies.

According to the first chemical-physical technology, the ceramic powders are mixed with a large quantity of plastic microspheres before the cold-moulding process.

Once the cold-moulding process is completed, the entire structure of the ring shows a diffuse presence of plastic microspheres, not only on surface layers, but also internally.

During the sintering process, the high temperature makes the microspheres melt progressively, leaving space to microporosity in the consolidated ceramic structure of the seal ring.

Although largely popular in view of its easy practical implementation, this traditional technology is impaired by two significant disadvantages.

The first disadvantage refers to the fact that, due to diffuse microporosity on the entire structure, the thermal and mechanical characteristics of the ring are lower compared to the characteristics of a dense, compact structure (that is to say a structure without the micro-alveoli initially occupied by plastic microspheres).

The second disadvantage refers to the need for specific measures for the disposal of the plastic waste obtained from melting the microspheres during high-temperature sintering.

An alternative technology has been devised, as mentioned above. This physical technology is implemented at the end of the sintering process of each seal ring by means of a laser texturing treatment performed directly on the front surface of the ring moulded from silicon carbide powders or equivalent ceramic materials.

Evidently, this treatment is particularly appreciated since it only affects the surface layer of the seal ring, without impairing the thermal and mechanical characteristics of the entire structure.

Nevertheless, this is a very sophisticated and expensive technology; additionally, the use of laser causes the formation of microcracks on the ceramic structure of the ring, in the proximity of the surface micro-cavities.

The specific purpose of the present invention is to devise an additional alternative technology capable of overcoming the aforementioned drawbacks of the prior technique.

More precisely, the new technology of the invention allows to obtain excellent micro-porosity, composed of non-interconnected surface micro-cavities, on the seal side of a ceramic ring by means of a traditional, inexpensive process (without using a laser generator), leaving the rest of the ring structure free from surface cracks or internal micro-porosity.

With respect to the prior technique, the peculiarity of the process of the invention consists in the fact that the treatment used to form the non-interconnected surface micro-cavities is produced for the first time during cold-moulding of ceramic powders and not during the following sintering process (such as in the case of treatment with plastic microspheres) or after the sintering process (such as in the case of laser treatment).

The inventive solution of the present invention—being a brilliant, inexpensive and efficacious idea—is that the non-interconnected surface micro-cavities of the seal ring are obtained using the head of the same punch used to mould the ceramic powders during cold-moulding.

The head of the punch is provided with a large series of punctiform micro-projections; evidently, the energetic impact of the head on the ceramic powders contained in the die has a double effect, i.e. the traditional compression of the said powders and the creation of a relief cavity on the upper surface of the ring, which corresponds exactly to the punctiform micro-projections on the head of the punch.

In other words, every micro-projection on the head of the punch generates one micro-cavity on the surface of the seal ring.

Moreover, it must be noted that at the end of the cold-moulding process, the ring can be subjected to hot sintering to give irreversible structural stability also to the micro-cavities obtained on the seal surface of the ring.

Finally, suitable punches can be selected to choose the morphological characteristics of the micro-porous surface, with reference to dimensions, density and distribution of the micro-cavities according to specific project needs.

1. Surface treatment process for ceramic mechanical seal rings of pumps having a plurality of non-interconnected surface micro-cavities, of the type comprising:
a first cold-moulding process of the ceramic powders loaded into the moulding die of the ring, wherein a punch for cold-moulding of these powders operates;
a second sintering process of the ring moulded in the first cold-moulding process, characterized in that the aforementioned plurality of non-interconnected micro-cavities is formed during the cold-moulding process of the ceramic powders by means of a punch having a head provided with non-interconnected punctiform micro-projections suitable for forming an exactly corresponding plurality of non-interconnected micro-cavities on the surface of the moulded ring.

2. (canceled)

3. Ceramic mechanical seal ring for pumps obtained with the process of claim 1.
